(19) United States
(12) Patent Application Publication
(10) Pub. No.: US 2024/0340807 A1
(43) Pub. Date: Oct. 10, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/744,731

(22) Filed: Jun. 17, 2024

Related U.S. Application Data
(63) Continuation of application No. PCT/CN2023/071131, filed on Jan. 7, 2023.

(30) Foreign Application Priority Data
Jan. 13, 2022 (CN) 202210037360.3

(51) Int. Cl. H04W 52/32; H04B 7/06; H04W 52/24; H04W 52/36

(52) U.S. Cl. CPC H04W 52/325; H04B 7/0639; H04W 52/242; H04W 52/367

(57) ABSTRACT

A node first receives a first information set, the first information set is used to indicate a first parameter set and a second parameter set; and receives a first signaling; then transmits a first signal; transmit power of the first signal is first power value; the first parameter set and the second parameter set are both associated with a first reference signal resource set, and the first signaling indicates a reference signal resource in the first reference signal resource set; a target parameter set is the first parameter set or the second parameter set, and the target parameter set is used to determine the first power value; whether the first signaling is used to indicate one reference signal resource in a second reference signal resource set is used to determine the target parameter set. The present application improves uplink power control under the multi-panel terminal to enhance system flexibility.

### CROSS REFERENCE TO RELATED APPLICATIONS

This application is the continuation of the international patent application No. PCT/CN2023/071131, filed on Jan. 7, 2023, and claims the priority benefit of Chinese Patent application Ser. No. 20/221,0037360.3, filed on Jan. 13, 2022, the full disclosure of which is incorporated herein by reference.

### BACKGROUND

### Technical Field

The present application relates to transmission methods and devices in wireless communication systems, and in particular to a transmission scheme and device for uplink power control in wireless communications.

### Related Art

The 5G wireless cellular communication network system (5G-RAN) has enhanced uplink power control of the UE on the basis of the original Long Term Evolution (LTE). Compared to LTE, since the NR system does not have a CRS (Common Reference Signal), the pathloss measurement required for uplink power control needs to be performed using CSI-RS (Channel State Information Reference Signal) and SSB (SS/PBCH Block). In addition, the most important feature of the NR system is the introduction of the beam management mechanism, terminals can communicate with multiple different transmit and receive beams, and thus the terminal needs to be able to measure multiple pathlosses corresponding to multiple beams, in which one way of determining the pathloss is to indicate certain associated downlink RS resources via an SRI (Sounding Reference Signal Resource Indicator) in DCI.

In the discussion of NR R17, the scenario of configuring multiple panels on the terminal side has been adopted, and the impact on power control brought by the introduction of multiple panels needs to be considered accordingly.

### SUMMARY

In the discussion of NR R17, enhancements have been made to the terminal's transmissions, one important aspect of which is the introduction of two Panels, which can be employed by the terminal to transmit simultaneously on two transmitting beams to obtain better spatial diversity gain. However, an important indicator of uplink transmission is power control, whether two panels use same power control parameters as one Panel when these two panels used at the same time and whether the power is dynamically distributed between two panels will affect the practice of uplink power control under multi-panel.

The present application discloses a solution for the problem of uplink power control under the multi-panel scenario mentioned above. It should be noted that in the description of the present application, multi-panel is only used as a typical application scenario or example; the present application is equally applicable to other scenarios facing similar problems, such as single-panel scenarios, or for different technical fields, such as technical fields other than uplink power control, such as measuring a reporting field, uplink data transmission, and other non-uplink power control fields, in order to achieve similar technical results. Additionally, the adoption of a unified solution for various scenarios, including but not limited to scenarios of multi-panel, contributes to the reduction of hardware complexity and costs. If no conflict is incurred, embodiments in a first node and the characteristics of the embodiments in the present application are also applicable to a second node, and vice versa. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:
receiving a first information set, the first information set being used to indicate a first parameter set and a second parameter set; and receiving a first signaling; and
transmitting a first signal;
herein, transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, one feature of the above method is in: two sets of power control parameter sets are configured, both of which correspond to a same given beam; when a given beam is used for single panel transmission, a set of parameters is adopted; when a given beam is used for simultaneous transmission of multi-panel, another set of parameters is adopted.

According to one aspect of the present application, when the first signaling is used to indicate at least one reference signal resource in the second reference signal resource set, the target parameter set is the second parameter set; when the first signaling is not used to indicate reference signal resources in the second reference signal resource set, the target parameter set is the first parameter set.

In one embodiment, one feature of the above method is in: indicating whether to use single panel transmission or multi-panel transmission through the first signaling.

According to one aspect of the present application, when the first signaling is used to indicate at least one reference signal resource in the second reference signal resource set, the first signal comprises a first sub-signal and a second sub-signal, and the first reference signal resource set and the second reference signal resource set are respectively used to determine Spatial Tx parameters of the first sub-signal and the second sub-signal; when the first signaling is not used to indicate reference signal resources in the second reference signal resource set, only the first reference signal resource set in the first reference signal resource set and the second reference signal resource set is used to determine Spatial Tx parameters of the first signal.

In one embodiment, one feature of the above method is in: for multi-Panel transmission, each panel is used to transmit a radio signal generated by a TB.

According to one aspect of the present application, the first parameter set comprises a first value, and the second parameter set comprises a second value and a third value; the first value and the second value are both for the first reference signal resource set, and the first value and the second value are different; when the first signaling is used to indicate at least one reference signal resource in the second reference signal resource set, the first signal comprises a first sub-signal and a second sub-signal, and the second value and the third value are respectively used to determine a transmit power value of the first sub-signal and a transmit power value the second sub-signal; when the first signaling is not used to indicate reference signal resources in the second reference signal resource set, the first value is used to determine a transmit power value of the first signal.

According to one aspect of the present application, the first parameter set comprises a first coefficient, and the second parameter set comprises a second coefficient and a third coefficient; when the first signaling is used to indicate at least one reference signal resource in the second reference signal resource set, the first signal comprises a first sub-signal and a second sub-signal, a product of the second coefficient and a first pathloss is used to determine a transmit power value of the first sub-signal, and a product of the third coefficient and a second pathloss is used to determine a transmit power value of the second sub-signal; when the first signaling is not used to indicate reference signal resources in the second reference signal resource set, a product of the first coefficient and a first pathloss is used to determine a transmit power value of the first signal; reference signal resources indicated by the first signaling in the first reference signal resource set are used to determine a third reference signal resource, and reference signal resources indicated by the first signaling in the second reference signal resource set are used to determine a fourth reference signal resource; a radio signal received in the third reference signal resource is used to determine the first pathloss, and a radio signal received in the fourth reference signal resource is used to determine the second pathloss.

According to one aspect of the present application, the first signaling comprises a first index group; when the first signaling is used to indicate at least one reference signal resource in the second reference signal resource set, the first signal comprises a first sub-signal and a second sub-signal, and the first index group is used to determine a pre-coding matrix indication respectively adopted by the first sub-signal and the second sub-signal; when the first signaling is not used to determine the second reference signal resource, the first index group is used to determine a precoding matrix indication adopted by the first signal.

According to one aspect of the present application, the first signaling comprises a first index group, the first index group is used to determine a first reference signal resource subset from the first reference signal resource set, or the first index group is used to simultaneously determine a first reference signal resource subset from the first reference signal resource set and a second reference signal resource subset from the second reference signal resource set.

The present application provides a method in a second node for wireless communications, comprising:
transmitting a first information set, the first information set being used to indicate a first parameter set and a second parameter set; and transmitting a first signaling; and
receiving a first signal;
herein, transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

According to one aspect of the present application: when the first signaling is used to indicate at least one reference signal resource in the second reference signal resource set, the target parameter set is the second parameter set; when the first signaling is not used to indicate reference signal resources in the second reference signal resource set, the target parameter set is the first parameter set.

According to one aspect of the present application; when the first signaling is used to indicate at least one reference signal resource in the second reference signal resource set, the first signal comprises a first sub-signal and a second sub-signal, and the first reference signal resource set and the second reference signal resource set are respectively used to determine Spatial Tx parameters of the first sub-signal and the second sub-signal; when the first signaling is not used to indicate reference signal resources in the second reference signal resource set, only the first reference signal resource set in the first reference signal resource set and the second reference signal resource set is used to determine Spatial Tx parameters of the first signal.

According to one aspect of the present application, the first parameter set comprises a first value, and the second parameter set comprises a second value and a third value; the first value and the second value are both for the first reference signal resource set, and the first value and the second value are different; when the first signaling is used to indicate at least one reference signal resource in the second reference signal resource set, the first signal comprises a first sub-signal and a second sub-signal, and the second value and the third value are respectively used to determine a transmit power value of the first sub-signal and a transmit power value the second sub-signal; when the first signaling is not used to indicate reference signal resources in the second reference signal resource set, the first value is used to determine a transmit power value of the first signal.

According to one aspect of the present application: the first parameter set comprises a first coefficient, and the second parameter set comprises a second coefficient and a third coefficient; when the first signaling is used to indicate at least one reference signal resource in the second reference signal resource set, the first signal comprises a first sub-signal and a second sub-signal, a product of the second coefficient and a first pathloss is used to determine a transmit power value of the first sub-signal, and a product of the third coefficient and a second pathloss is used to determine a transmit power value of the second sub-signal; when the first signaling is not used to indicate reference signal resources in the second reference signal resource set, a product of the first coefficient and a first pathloss is used to determine a transmit power value of the first signal; reference signal resources indicated by the first signaling in the first reference signal resource set are used to determine a third reference signal resource, and reference signal resources indicated by the first signaling in the second reference signal resource set are used to determine a fourth reference signal resource; a radio signal received in the third reference signal resource is used to determine the first pathloss, and a radio signal received in the fourth reference signal resource is used to determine the second pathloss.

According to one aspect of the present application, the first signaling comprising a first index group; when the first signaling is used to indicate at least one reference signal resource in the second reference signal resource set, the first signal comprises a first sub-signal and a second sub-signal, and the first index group is used to determine a pre-coding matrix indication respectively adopted by the first sub-signal and the second sub-signal; when the first signaling is not used to determine the second reference signal resource, the first index group is used to determine a precoding matrix indication adopted by the first signal.

According to one aspect of the present application: the first signaling comprises a first index group, the first index group is used to determine a first reference signal resource subset from the first reference signal resource set, or the first index group is used to simultaneously determine a first reference signal resource subset from the first reference signal resource set and a second reference signal resource subset from the second reference signal resource set.

The present application provides a first node for wireless communications, comprising:
a first receiver, receiving a first information set, the first information set being used to indicate a first parameter set and a second parameter set; and receiving a first signaling; and
a first transmitter, transmitting a first signal;
herein, transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

The present application provides a second node for wireless communications, comprising:
a second transmitter, transmitting a first information set, the first information set being used to indicate a first parameter set and a second parameter set; and transmitting a first signaling; and
a second receiver, receiving a first signal;
herein, transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, advantages of the scheme in the present application are: improving the flexibility of uplink power control under multi-panel, thereby improving power control efficiency and transmission performance.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a first signal according to one embodiment of the present application;

FIG. 6 illustrates a schematic diagram of a first information set according to one embodiment of the present application;

FIG. 7 illustrates a schematic diagram of a first reference signal resource set and a second reference signal resource set according to one embodiment of the present application;

FIG. 8 illustrates a schematic diagram of a first signaling according to one embodiment of the present application;

FIG. 9 illustrates a schematic diagram of a first node according to one embodiment of the present application;

FIG. 10 illustrates a schematic diagram of antenna ports and antenna port groups according to one embodiment of the present application;

FIG. 11 illustrates a structure block diagram of a processor in a first node according to one embodiment of the present application;

FIG. 12 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of the processing of a first node, as shown in FIG. 1. In step 100 illustrated by FIG. 1, each box represents a step. In embodiment 1, the first node in the present application receives a first information set in step 101, and the first information set is used to indicate a first parameter set and a second parameter set; receives a first signaling in step 102; transmits a first signal in step 103.

In embodiment 1, transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, the first information set is transmitted through a Radio Resource Control (RRC) signaling.

In one embodiment, the first information set is configured through an RRC signaling.

In one embodiment, an RRC signaling transmitting or configuring the first information set comprises one or multiple fields in PUSCH-PowerControl in Specification.

In one embodiment, an RRC signaling transmitting or configuring the first information set comprises PUSCH-PowerControl in Specification.

In one embodiment, an RRC signaling transmitting or configuring the first information set comprises PUSCH-P0-PUSCH-AlphaSet in Specification.

In one embodiment, an RRC signaling transmitting or configuring the first information set comprises one or multiple fields in SRI-PUSCH-PowerControl in Specification.

In one embodiment, an RRC signaling transmitting or configuring the first information set comprises SRI-PUSCH-PowerControl in Specification.

In one embodiment, a name of an RRC signaling transmitting or configuring the first information set comprises Power.

In one embodiment, a name of an RRC signaling transmitting or configuring the first information set comprises Control.

In one embodiment, a name of an RRC signaling transmitting or configuring the first information set comprises a PUSCH (Physical Uplink Shared Channel).

In one embodiment, a name of an RRC signaling transmitting or configuring the first information set comprises an SRS (Sound Reference Signal).

In one embodiment, a name of an RRC signaling transmitting or configuring the first information set comprises SRI.

In one embodiment, a physical-layer channel occupied by the first signaling comprises a Physical Downlink Control Channel (PDCCH).

In one embodiment, the first signaling is Downlink Control Information (DCI).

In one embodiment, a physical-layer channel occupied by the first signal comprises a PUSCH.

In one embodiment, the first signal is an SRS.

In one embodiment, the first power value is measured by dBm.

In one embodiment, the first signaling is used to schedule a transmission of the first signal.

In one embodiment, the first signaling is used to indicate at least one of time-domain resources or frequency-domain resources occupied by the first signal.

In one embodiment, the first signaling is used to trigger a transmission of the first signal.

In one embodiment, the first signaling is used to indicate a Modulation and Coding Scheme (MCS) of the first signal.

In one embodiment, the first signaling is used to indicate a HARQ process number of the first signal.

In one embodiment, the first reference signal resource set and the second reference signal resource set are respectively identified by different SRS ResourceSetIds.

In one embodiment, the first reference signal resource set corresponds to an SRS resource set.

In one embodiment, the first reference signal resource set comprises a reference signal resource.

In one subembodiment of the embodiment, the reference signal resource comprised in the first reference signal resource set is an SRS Resource.

In one embodiment, the first reference signal resource set comprises K1 reference signal resources, K1 being a positive integer greater than 1.

In one subembodiment of the embodiment, any of the K1 reference signal resources comprised in the first reference signal resource set is an SRS Resource.

In one subembodiment of the embodiment, there exists at least one of the K1 reference signal resources comprised in the first reference signal resource set being an SRS Resource.

In one embodiment, the second reference signal resource set comprises a reference signal resource.

In one subembodiment of the embodiment, the reference signal resource comprised in the second reference signal resource set is an SRS Resource.

In one embodiment, the second reference signal resource set comprises K2 reference signal resources, K2 being a positive integer greater than 1.

In one subembodiment of the embodiment, any of the K2 reference signal resources comprised in the second reference signal resource set is an SRS Resource.

In one subembodiment of the embodiment, there at least exists one of the K2 reference signal resources comprised in the second reference signal resource set being an SRS Resource.

In one embodiment, the meaning of the above phrase that the first parameter set and the second parameter set are both associated with a first reference signal resource set comprises: parameters in the first parameter set are used to determine a transmit power value of a radio signal transmitted in at least one reference signal resource in the first reference signal resource set, or parameters in the second parameter set are used to determine a transmit power value of a radio signal transmitted in at least one reference signal resource in the first reference signal resource set.

In one embodiment, the meaning of the above phrase that the first parameter set and the second parameter set are both associated with a first reference signal resource set comprises: parameters in the first parameter set are used to determine a transmit power value of a target radio signal, and the target radio signal and a radio signal transmitted in at least one reference signal resource in the first reference signal resource set are QCLed (Quasi Co-located); or parameters in the second parameter set are used to determine a transmit power value of a target radio signal, and the target radio signal and a radio signal transmitted from at least one reference signal resource in the first reference signal resource set are QCLed.

In one embodiment, the meaning of the above phrase that the first parameter set and the second parameter set are both associated with a first reference signal resource set comprises: the first parameter set is associated with a first reference signal resource set in the first reference signal resource set, and the second parameter set is associated with the first reference signal resource set in the first reference signal resource set.

In one subembodiment of the embodiment, the first reference signal resource corresponds to an SRS Resource.

In one subembodiment of the embodiment, the first reference signal resource corresponds to an SRS-ResourceID.

In one subembodiment of the embodiment, the first signaling is used to indicate the first reference signal resource in the first reference signal resource set.

In one subembodiment of the embodiment, the first parameter set comprises K1 first parameter groups, and the second parameter set comprises K1 second parameter groups; the first reference signal resource set comprises K1 reference signal resources; the K1 first parameter groups respectively correspond to the K1 reference signal resources comprised in the first reference signal resource set, and the K1 second parameter groups respectively correspond to the K1 reference signal resources comprised in the first reference signal resource set.

In one subsidiary embodiment of the subembodiment, a given reference signal resource is any of the K1 reference signal resources, and the given reference signal resource corresponds to a given first parameter group in the K1 first parameter groups and a given second parameter group in the K1 second parameter groups; when the first signal is only generated by one TB, the given first parameter set is used to determine a transmit power value of the first signal; when the first signal is generated by two TBs, the given second parameter set is used to determine a transmit power value of the first signal.

In one subsidiary embodiment of the subembodiment, a given reference signal resource is any of the K1 reference signal resources, and the given reference signal resource corresponds to a given first parameter group in the K1 first parameter groups and a given second parameter group in the K1 second parameter groups; when the first signal only occupies one reference signal resource in the first reference signal resource set, the given first parameter group is used to determine a transmit power value of the first signal; when the first signal occupies one reference signal resource in the first reference signal resource set and one reference signal resource in the second reference signal resource set, the given second parameter set is used to determine a transmit power value of the first signal.

In one subsidiary embodiment of the subembodiment, a given reference signal resource is any of the K1 reference signal resources, and the given reference signal resource corresponds to a given first parameter group in the K1 first parameter groups and a given second parameter group in the K1 second parameter groups; when the first signal is only QCLed with a radio signal transmitted in a reference signal resource in the first reference signal resource set, the given first parameter set is used to determine a transmit power value of the first signal; when the first signal comprise a first sub-signal and a second sub-signal, and the first sub-signal and a radio signal transmitted in a reference signal resource in the first reference signal resource set are QCLed, when the second sub-signal and a radio signal transmitted in a reference signal resource in the second reference signal resource set are QCLed, the given second parameter set is used to determine a transmit power value of the first signal.

In one embodiment, for a same type of parameters, a number of parameters comprised in the first parameter set is not greater than a number of parameters comprised in the second parameter set.

In one embodiment, for a same type of parameters, a number of parameters comprised in the first parameter set is less than a number of parameters comprised in the second parameter set.

In one embodiment, for a same type of parameters, a number of parameters comprised in the second parameter set is twice a number of parameters comprised in the first parameter set.

In one embodiment, the first signal comprises a target index; when a value of the target index is a value in a first candidate value set, the first signaling is used to indicate at least one reference signal resource in the first reference signal resource set; when a value of the target index is a value in a second candidate value set, the first signaling is used to simultaneously indicate at least one reference signal resource in the first reference signal resource set and at least one reference signal resource in the second reference signal resource set.

In one subembodiment of the embodiment, the first candidate value set comprises multiple candidate values.

In one subembodiment of the embodiment, the second candidate value set comprises multiple candidate values.

In one subembodiment of the embodiment, any candidate value in the first candidate value set is different from any candidate value in the second candidate value set.

In one embodiment, the first signaling comprises a first index group.

In one subembodiment of the embodiment, the first index group comprised in the first signaling is used to indicate at least one reference signal resource in the first reference signal resource set.

In one subembodiment of the embodiment, the first index group comprised in the first signaling is used to indicate at least one reference signal resource in the second reference signal resource set.

In one subembodiment of the embodiment, the first index group comprised in the first signaling is simultaneously used to indicate at least one reference signal resource in the first reference signal resource set and at least one reference signal resource in the second reference signal resource set.

In one embodiment, the meaning of the above phrase that the second reference signal resource set and the first reference signal resource set are different comprises: the second reference signal resource set adopts a first identifier, the first reference signal resource set adopts a second identifier, and the first identifier and the second identifier are different.

In one subembodiment of the embodiment, both the first identifier and the second identifier are SRSResourceSetIDs.

In one subembodiment of the embodiment, both the first identifier and the second identifier are Panel IDs.

In one embodiment, the meaning of the above phrase that the second reference signal resource set and the first reference signal resource set are different comprises: there at least exists one target reference signal resource in the second reference signal resource set, and there at least exists one given reference signal resource in the first reference signal resource set, and a radio signal transmitted in the target reference signal resource is non QCLed with a radio signal transmitted in the given reference signal resource set.

In one embodiment, the meaning of the above phrase that the second reference signal resource set and the first reference signal resource set are different comprises: a radio signal transmitted from any reference signal resource in the second reference signal resource set is non QCLed with a radio signal transmitted from any reference signal resource in the first reference signal resource set.

In one embodiment, the first signal is a radio signal.

In one embodiment, the first signal is a baseband signal.

### Embodiment 2

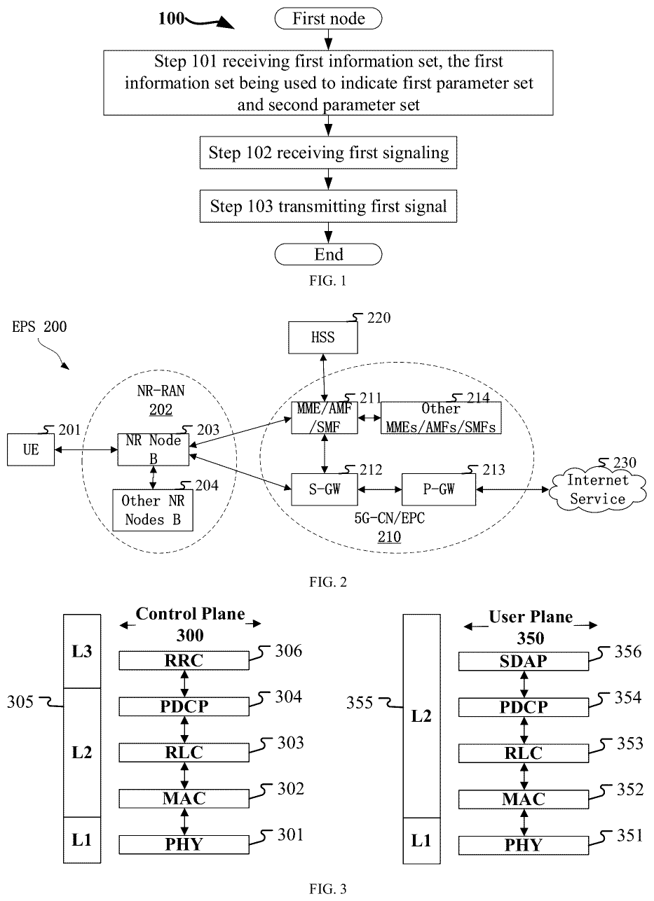

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports simultaneous transmission of multiple panels.

In one embodiment, the UE 201 supports power sharing between multiple panels.

In one embodiment, the UE 201 supports multiple uplink RF (Radio Frequency).

In one embodiment, the UE 201 supports simultaneous transmission of multiple uplink RF.

In one embodiment, the UE 201 supports reporting multiple sets of UE capability values.

In one embodiment, the NR node B corresponds to the second node in the present application.

In one embodiment, the NR node B supports receiving signals from multiple panels of a terminal at the same time.

In one embodiment, the NR node B supports receiving a signal transmitted by multiple uplink RF (Radio Frequency) from a same terminal.

In one embodiment, the NR node B is a base station.

In one embodiment, the NR node B is a cell.

In one embodiment, the NR node B comprises multiple cells.

In one embodiment, the first node in the present application corresponds to the UE 201, and the second node in the present application corresponds to the NR node B.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first information set is generated by the MAC 302 or the MAC 352.

In one embodiment, the first information set is generated by the RRC 306.

In one embodiment, the first signaling is generated by the MAC 302 or the MAC 352.

In one embodiment, the first signaling is generated by the PHY 301 or the PHY 351.

In one embodiment, the first signal is generated by the MAC 302 or the MAC 352.

In one embodiment, the first signal is generated by the RRC 306.

In one embodiment, the first signal is generated by the PHY 301 or the PHY 351.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used to manage multiple TRPs.

In one embodiment, the second node is a node used for managing multiple cells.

### Embodiment 4

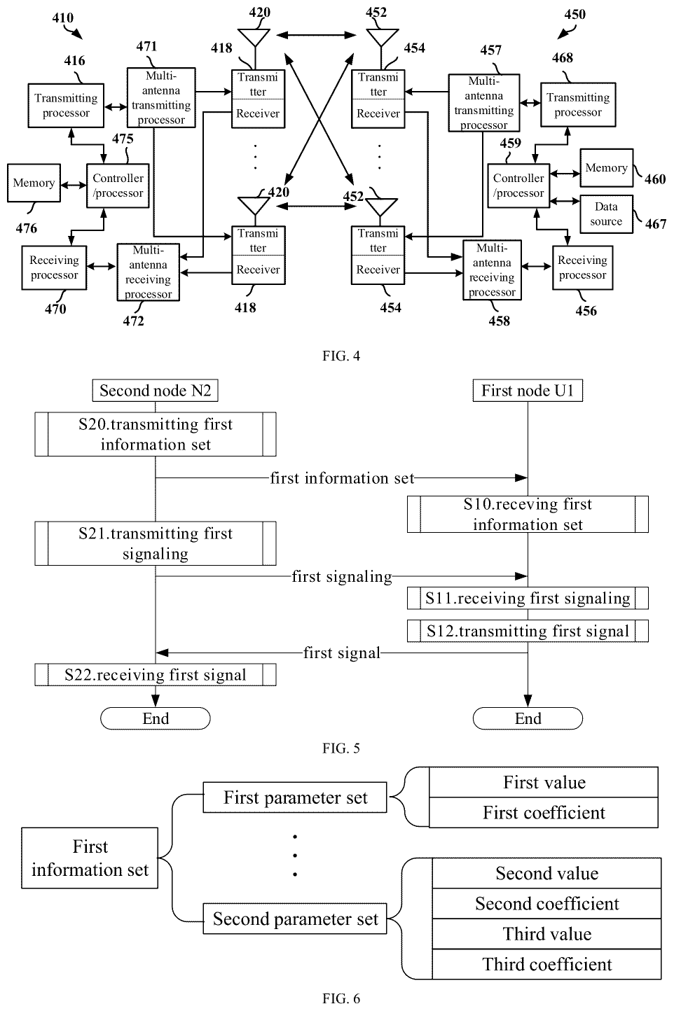

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first information set, the first information set is used to indicate a first parameter set and a second parameter set; then receives a first signaling; and transmits a first signal; transmit power of the first signal is first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, the first communication device 450 comprises at least one processor and at least one memory. a memory that stores a computer readable instruction program. The computer readable instruction program generates an action when executed by at least one processor. The action includes: first receiving a first information set, the first information set being used to indicate a first parameter set and a second parameter set; then receiving a first signaling; and transmitting a first signal; transmit power of the first signal being first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first information set, the first information set is used to indicate a first parameter set and a second parameter set; then transmits a first signaling; and receives a first signal; transmit power of the first signal is first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, the second communication device 410 comprises a memory that stores a computer readable instruction program. The computer readable instruction program generates an action when executed by at least one processor. The action includes: first transmitting a first information set, the first information set being used to indicate a first parameter set and a second parameter set; then transmitting a first signaling; and receiving a first signal; transmit power of the first signal is first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first information set; at least first four of the antenna 420, the transmitter 418, the multi-antenna transmitting processor 471, the transmitting processor 416 and the controller/processor 475 are used to transmit a first information set.

In one embodiment, at least first four of the antenna 452, the receiver 454, the multi-antenna receiving processor 458, the receiving processor 456 and the controller/processor 459 are used to receive first signaling; at least first four of the antenna 420, the transmitter 418, the multi-antenna transmitting processor 471, the transmitting processor 416 and the controller/processor 475 are used to transmit a first signaling.

In one embodiment, at least first four of the antenna 452, the transmitter 454, the multi-antenna transmitting processor 457, the transmitting processor 468, and the controller/processor 459 are used to transmit a first signal; at least first four of the antenna 420, the receiver 418, the multi-antenna receiving processor 472, the receiving processor 470 and the controller/processor 475 are used to receive a first signal.

### Embodiment 5

Embodiment 5 illustrates a flowchart of a first signal, as shown in FIG. 5. In FIG. 5, a first node U1 and a second node N2 are in communications via a radio link. It is particularly underlined that the order illustrated in the embodiment does not put constraints over sequences of signal transmissions and implementations.

The first node U1 receives a first information set in step S10; receives a first signaling in step S11; and transmits a first signal in step S12.

The second node N2 transmits a first information set in step S20; transmits a first signaling in step S21; receives a first signal in step S22.

In embodiment 5, the first information set is used to indicate a first parameter set and a second parameter set; transmit power of the first signal is first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

Typically; when the first signaling is used to indicate at least one reference signal resource in the second reference signal resource set, the target parameter set is the second parameter set; when the first signaling is not used to indicate reference signal resources in the second reference signal resource set, the target parameter set is the first parameter set.

In one embodiment, the first signaling comprises a target index and a first index group, and the target index is used to indicate whether the first index group is used to indicate at least one reference signal resource from the first reference signal resource set.

In one embodiment, the first signaling comprises a target index and a first index group, and the target index is used to indicate whether the first index group is used to indicate at least one reference signal resource from the second reference signal resource set.

In one embodiment, the first signaling comprises a target index and a first index group, and the target index is used to indicate whether the first index group is used to indicate at least one reference signal resource from the first reference signal resource set, and indicate at least one reference signal resource from the second reference signal resource set.

In one embodiment, the first signaling comprises a target index and a first index group, and the target index is used to determine the first index group.

In one subembodiment of the embodiment, the target index is used to determine an interpretation of the first index group.

In one subembodiment of the embodiment, the target index is used to determine meaning of the first index group.

In one subembodiment of the embodiment, the target index is used to determine a number of bit(s) occupied by the first index group.

In one subembodiment of the embodiment, a value of the target index is used to determine that the first index group is used to indicate a reference signal resource from the first reference signal resource set.

In one subsidiary embodiment of the subembodiment, a value of the target index is a value in the first candidate value set, and the first candidate value set comprises multiple candidate values.

In one subsidiary embodiment of the subembodiment, the first index group comprises an SRI, and the SRI comprised in the first index group is used to indicate a reference signal resource from the first reference signal resource set.

In one subsidiary embodiment of the subembodiment, the first index group comprises a precoding matrix indicator (PMI), and the PMI comprised in the first index group is used to indicate a PMI adopted by the first signal.

In one subembodiment of the embodiment, a value of the target index is used to determine that the first index group is used to indicate a reference signal resource from the first reference signal resource set and indicate a reference signal resource from the second reference signal resource set at the same time.

In one subsidiary embodiment of the subembodiment, a value of the target index is a value in the second candidate value set, and the second candidate value set comprises multiple candidate values.

In one subsidiary embodiment of the subembodiment, the first index group comprises two SRIs, the two SRIs comprised in the first index group are used to respectively indicate a reference signal resource from the first reference signal resource set and a reference signal resource from the second reference signal resource set.

In one subsidiary embodiment of the subembodiment, the first index group comprises two PMIs, the first signal comprises a first sub-signal and a second sub-signal, and the two PMIs comprised in the first index group are respectively used to indicate a PMI adopted by the first sub-signal and a PMI adopted by the second sub-signal.

Typically; when the first signaling is used to indicate at least one reference signal resource in the second reference signal resource set, the first signal comprises a first sub-signal and a second sub-signal, and the first reference signal resource set and the second reference signal resource set are respectively used to determine Spatial Tx parameters of the first sub-signal and the second sub-signal; when the first signaling is not used to indicate reference signal resources in the second reference signal resource set, only the first reference signal resource set in the first reference signal resource set and the second reference signal resource set is used to determine Spatial Tx parameters of the first signal.

In one embodiment, a physical-layer channel occupied by the first sub-signal comprises a PUSCH.

In one embodiment, a physical-layer channel occupied by the second sub-signal comprises a PUSCH.

In one embodiment, the first sub-signal is generated through a TB.

In one embodiment, the second sub-signal is generated through a TB.

In one subembodiment of the above two embodiments, a TB generating the first sub-signal is different from a TB generating the second sub-signal.

In one subembodiment of the above two embodiments, a TB generating the first sub-signal and a TB generating the second sub-signal respectively adopt different HARQ process numbers.

In one subembodiment of the above two embodiments, a TB generating the first sub-signal is the same as a TB generating the second sub-signal.

In one subembodiment of the above two embodiments, a TB generating the first sub-signal and a TB generating the second sub-signal adopt a same HARQ process number.

In one embodiment, the first sub-signal is an SRS.

In one embodiment, the second sub-signal is an SRS.

In one embodiment, when the first signaling is used to indicate at least one reference signal resource in the second reference signal resource set, the first signaling is used to indicate a first reference signal resource from the first reference signal resource set, and the first signaling is used to indicate a second reference signal resource from the second reference signal resource set, the first reference signal resource is used to determine Spatial Tx parameters of the first sub-signal, and the second reference signal resource is used to determine Spatial Tx parameters of the second sub-signal.

In one subembodiment of the embodiment, the meaning of the above phrase that the first reference signal resource is used to determine Spatial Tx parameters of the first sub-signal comprises: the first sub-signal and a radio signal transmitted in the first reference signal resource are QCLed.

In one subembodiment of the embodiment, the meaning of the above phrase that the first reference signal resource is used to determine Spatial Tx parameters of the first sub-signal comprises: the first sub-signal and a radio signal transmitted in the first reference signal resource adopt same Spatial Tx parameters.

In one subembodiment of the embodiment, the meaning of the above phrase that the second reference signal resource is used to determine Spatial Tx parameters of the second sub-signal comprises: the second sub-signal and a radio signal transmitted in the second reference signal resource are QCLed.

In one subembodiment of the embodiment, the meaning of the above phrase that the second reference signal resource is used to determine Spatial Tx parameters of the second sub-signal comprises: the second sub-signal and a radio signal transmitted in the second reference signal resource adopt same Spatial Tx parameters.

In one embodiment, when the first signaling is not used to indicate at least one reference signal resource in the second reference signal resource set, the first signaling is only used to indicate a first reference signal resource from the first reference signal resource set, and the first reference signal resource is used to determine Spatial Tx parameters of the first signal.

In one subembodiment of the embodiment, the meaning of the above phrase that the first reference signal resource is used to determine Spatial Tx parameters of the first sub-signal comprises: the first sub-signal and a radio signal transmitted in the first reference signal resource are QCLed.

In one subembodiment of the embodiment, the meaning of the above phrase that the first reference signal resource is used to determine Spatial Tx parameters of the first sub-signal comprises: the first sub-signal and a radio signal transmitted in the first reference signal resource adopt same Spatial Tx parameters.

In one embodiment, the QCL refers to Quasi Co-Located.

In one embodiment, the QCL refers to Quasi Co-Location.

In one embodiment, the QCL comprises QCL parameter.

In one embodiment, the QCL comprises a QCL assumption.

In one embodiment, a type of the QCL comprises QCL-TypeA.

In one embodiment, a type of the QCL comprises QCL-TypeB.

In one embodiment, a type of the QCL comprises QCL-TypeC.

In one embodiment, a type of the QCL comprises QCL-TypeD.

In one embodiment, the QCL TypeA comprises Doppler shift, Doppler spread, average delay, and delay spread.

In one embodiment, the QCL TypeB comprises Doppler shift and Doppler spread.

In one embodiment, the QCL TypeC comprises Doppler shift and average delay.

In one embodiment, the QCL-TypeD comprises Spatial Rx parameter.

In one embodiment, the QCL parameters comprise at least one of delay spread, Doppler spread, Doppler shift, average delay, Spatial Tx parameter or Spatial Rx parameter.

In one embodiment, the Spatial Tx parameter comprises at least one of transmitting antenna port, transmitting antenna port set, transmitting beam, transmitting analog beamforming matrix, transmitting analog beamforming vector, transmitting beamforming matrix, transmitting beamforming vector or spatial-domain transmission filter.

In one embodiment, the Spatial Rx parameter comprises at least one of receiving beam, receiving analog beamforming matrix, receiving analog beamforming vector, receiving beamforming matrix, receiving beamforming vector or spatial-domain reception filter.

Typically, the first parameter set comprises a first value, and the second parameter set comprises a second value and a third value; the first value and the second value are both for the first reference signal resource set, and the first value and the second value are different; when the first signaling is used to indicate at least one reference signal resource in the second reference signal resource set, the first signal comprises a first sub-signal and a second sub-signal, and the second value and the third value are respectively used to determine a transmit power value of the first sub-signal and a transmit power value the second sub-signal; when the first signaling is not used to indicate reference signal resources in the second reference signal resource set, the first value is used to determine a transmit power value of the first signal.

In one embodiment, when the target parameter set is the first parameter set, the candidate parameter comprises the first value.

In one embodiment, when the target parameter set is the second parameter set, the candidate parameter comprises the second value and the third value.

In one embodiment, the first value is measured by dBm.

In one embodiment, the first value is a P0.

In one embodiment, the second value is measured by dBm.

In one embodiment, the second value is a P0.

In one embodiment, the third value is measured by dBm.

In one embodiment, the third value is a P0.

In one embodiment, the first value and the second value are both associated with a reference signal resource in the first reference signal resource set.

In one embodiment, the first value and the second value are both associated with a first reference signal resource in the first reference signal resource set, and the first signaling is used to indicate the first reference signal resource from the first reference signal resource set.

In one embodiment, when the first value is used to determine a transmit power value of the first signal, a transmit power value of the first signal is not greater than a first threshold value, and the first value is linearly correlated to a transmit power value of the first signal.

In one subembodiment of the embodiment, a linear coefficient between the first value and a transmit power value of the first signal is equal to 1.

In one subembodiment of the embodiment, the first threshold value is PCMAX.

In one subembodiment of the embodiment, the first threshold value is per SRS Resource Set.

In one embodiment, when the second value and the third value are respectively used to determine a transmit power value of the first sub-signal and a transmit power value of the second sub-signal, and a transmit power value of the first sub-signal and a transmit power value of the second sub-signal are respectively not greater than a second threshold value and a third threshold value, the second value is linearly correlated to a transmit power value of the first sub-signal, and the third value is linearly correlated to a transmit power value of the second sub-signal.

In one subembodiment of the embodiment, a linear coefficient between the second value and a transmit power value of the first sub-signal is equal to 1.

In one subembodiment of the embodiment, a linear coefficient between the third value and a transmit power value of the second sub-signal is equal to 1.

In one subembodiment of the embodiment, the second threshold value is PCMAX.

In one subembodiment of the embodiment, the third threshold value is PCMAX.

In one subembodiment of the embodiment, the second threshold value is per SRS Resource Set.

In one subembodiment of the embodiment, the third threshold value is per SRS Resource Set.

In one embodiment, the first threshold value in the present application is equal to the second threshold value.

In one embodiment, the second threshold value in the present application is equal to the third threshold value.

In one embodiment, the first threshold value in the present application is equal to a sum of the second threshold value and the third threshold value.

Typically, the first parameter set comprises a first coefficient, and the second parameter set comprises a second coefficient and a third coefficient; when the first signaling is used to indicate at least one reference signal resource in the second reference signal resource set, the first signal comprises a first sub-signal and a second sub-signal, a product of the second coefficient and a first pathloss is used to determine a transmit power value of the first sub-signal, and a product of the third coefficient and a second pathloss is used to determine a transmit power value of the second sub-signal; when the first signaling is not used to indicate reference signal resources in the second reference signal resource set, a product of the first coefficient and a first pathloss is used to determine a transmit power value of the first signal; reference signal resources indicated by the first signaling in the first reference signal resource set are used to determine a third reference signal resource, and reference signal resources indicated by the first signaling in the second reference signal resource set are used to determine a fourth reference signal resource; a radio signal received in the third reference signal resource is used to determine the first pathloss, and a radio signal received in the fourth reference signal resource is used to determine the second pathloss.

In one embodiment, when the target parameter set is the first parameter set, the candidate parameter comprises the first coefficient.

In one embodiment, when the target parameter set is the second parameter set, the candidate parameter comprises the second coefficient and the third coefficient.

In one embodiment, the first coefficient is not greater than 1.

In one embodiment, the first coefficient is a real number between 0 and 1.

In one embodiment, the second coefficient is not greater than 1.

In one embodiment, the second coefficient is a real number between 0 and 1.

In one embodiment, the second coefficient is not greater than 1.

In one embodiment, the second coefficient is a real number between 0 and 1.

In one embodiment, the first coefficient is different from the second coefficient.

In one embodiment, the first coefficient is the same as the second coefficient.

In one embodiment, the first coefficient is unrelated to the second coefficient.

In one embodiment, the first coefficient is related to the second coefficient.

In one embodiment, the first coefficient and the second coefficient are independently configured.

In one embodiment, the first coefficient and the second coefficient are jointly configured.

In one embodiment, the third coefficient is different from the second coefficient.

In one embodiment, the third coefficient is the same as the second coefficient.

In one embodiment, the third coefficient is unrelated to the second coefficient.

In one embodiment, the third coefficient is related to the second coefficient.

In one embodiment, the third coefficient and the second coefficient are independently configured.

In one embodiment, the third coefficient and the second coefficient are jointly configured.

In one embodiment, the third reference signal resource is a CSI-RS resource.

In one embodiment, the third reference signal resource is an SSB.

In one embodiment, the fourth reference signal resource is a CSI-RS resource.

In one embodiment, the fourth reference signal resource is an SSB.

In one embodiment, a first reference signal resource in the first reference signal resource set is indicated by the first signaling, and the first reference signal resource is used to determine the third reference signal resource.

In one subembodiment of the embodiment, a radio signal transmitted in the first reference signal resource and a radio signal transmitted in the third reference signal resource are QCLed.

In one subembodiment of the embodiment, an ssb-Index or csi-RS-Index corresponding to the third reference signal resource is associated with a pusch-PathlossReferenceRS-Id corresponding to the first reference signal resource.

In one embodiment, a second reference signal resource in the second reference signal resource set is indicated by the first signaling, and the second reference signal resource is used to determine the fourth reference signal resource.

In one embodiment, a radio signal transmitted in the second reference signal resource and a radio signal transmitted in the fourth reference signal resource are QCLed.

In one subembodiment of the embodiment, an ssb-Index or csi-RS-Index corresponding to the fourth reference signal resource is associated with a pusch-PathlossReferenceRS-Id corresponding to the second reference signal resource.

In one embodiment, the first pathloss is measured by dB.

In one embodiment, the second pathloss is measured by dB.

In one embodiment, when a product of the second coefficient and the first pathloss is used to determine a transmit power value of the first sub-signal, a product of the third coefficient and the second pathloss is used to determine a transmit power value of the second sub-signal, and a transmit power value of the first sub-signal and a transmit power value of the second sub-signal are respectively not greater than a second threshold value and a third threshold value, a product of the second coefficient and the first pathloss is linearly correlated to a transmit power value of the first sub-signal, and a product of the third coefficient and the second pathloss is linearly correlated to a transmit power value of the second sub-signal.

In one subembodiment of the embodiment, a linear coefficient between a product of the second coefficient and the first pathloss and a transmit power value of the first sub-signal is equal to 1.

In one subembodiment of the embodiment, a linear coefficient between a product of the third coefficient and the second pathloss and a transmit power value of the second sub-signal is equal to 1.

In one embodiment, when a product of the first coefficient and the first pathloss is used to determine a transmit power value of the first signal, and a transmit power value of the first signal is not greater than a first threshold value, a product of the first coefficient and the first pathloss is linearly correlated to a transmit power value of the first signal.

In one subembodiment of the embodiment, a linear coefficient between a product of the first coefficient and the first pathloss and a transmit power value of the first signal is equal to 1.

Typically, the first signaling comprising a first index group; when the first signaling is used to indicate at least one reference signal resource in the second reference signal resource set, the first signal comprises a first sub-signal and a second sub-signal, and the first index group is used to determine a pre-coding matrix indication respectively adopted by the first sub-signal and the second sub-signal; when the first signaling is not used to determine the second reference signal resource, the first index group is used to determine a precoding matrix indication adopted by the first signal.

In one embodiment, when the first signaling is used to indicate at least one reference signal resource in the second reference signal resource set, the first index group is used to indicate a first PMI and a second PMI, respectively, and the first PMI and the second PMI respectively indicate a precoding matrix adopted by the first sub-signal and a precoding matrix adopted by the second sub-signal.

In one embodiment, when the first signaling is not used to determine the second reference signal resource, the first index group is used to indicate a first PMI, and the first PMI indicates a precoding matrix used by the first signal.

Typically, the first signaling comprises a first index group, the first index group is used to determine a first reference signal resource subset from the first reference signal resource set, or the first index group is used to simultaneously determine a first reference signal resource subset from the first reference signal resource set and a second reference signal resource subset from the second reference signal resource set.

In one embodiment, the first reference signal resource subset comprises K3 reference signal resources, K3 being a positive integer greater than 1, and the K3 reference signal resources comprise the first reference signal resources.

In one subembodiment of the above embodiment, the K3 reference signal resources are respectively K3 SRS resources.

In one embodiment, the second reference signal resource subset comprise K4 reference signal resources, K4 being a positive integer greater than 1, and the K4 reference signal resources comprise the second reference signal resource.

In one subembodiment of the above embodiment, the K4 reference signal resources are respectively K4 SRS resources.

### Embodiment 6

Embodiment 6 illustrates a schematic diagram of a first information set, as shown in FIG. 6. In FIG. 6, the first information set comprises a first parameter set and a second parameter set; the first parameter set comprises a first value and a first coefficient; the second parameter set comprises a second value, a third value, a second coefficient, and a third coefficient.

In one embodiment, the first value is P0 in TS 38.331, and the first coefficient is Alpha in TS 38.331.

In one embodiment, the second value and the third value are both P0 in TS 38.331, and the second coefficient and the third coefficient are both Alpha in TS 38.331.

In one embodiment, the first value and the first coefficient are both associated with at least one reference signal resource in the first reference signal resource set.

In one embodiment, the first value and the first coefficient are both associated with all reference signal resources in the first reference signal resource set.

In one embodiment, the first value and the first coefficient are both associated with the first reference signal resource in the first reference signal resource set.

In one embodiment, the first value and the first coefficient are only used when one SRS resource set of the first node is indicated.

In one embodiment, the second value and the second coefficient are both associated with at least one reference signal resource in the first reference signal resource set.

In one embodiment, the second value and the second coefficient are both associated with all reference signal resources in the first reference signal resource set.

In one embodiment, the second value and the second coefficient are both associated with the first reference signal resource in the first reference signal resource set.

In one embodiment, the second value and the second coefficient are only used when both reference signal resources in the first reference signal resource set and reference signal resources in the second reference signal resource set of the first node are indicated.

In one embodiment, the third value and the third coefficient are both associated with at least one reference signal resource in the second reference signal resource set.

In one embodiment, the third value and the third coefficient are both associated with all reference signal resources in the second reference signal resource set.

In one embodiment, the third value and the third coefficient are both associated with the second reference signal resource in the second reference signal resource set.

In one embodiment, the third value and the third coefficient are only used when both reference signal resources in the first reference signal resource set and reference signal resources in the second reference signal resource set of the first node are indicated.

### Embodiment 7

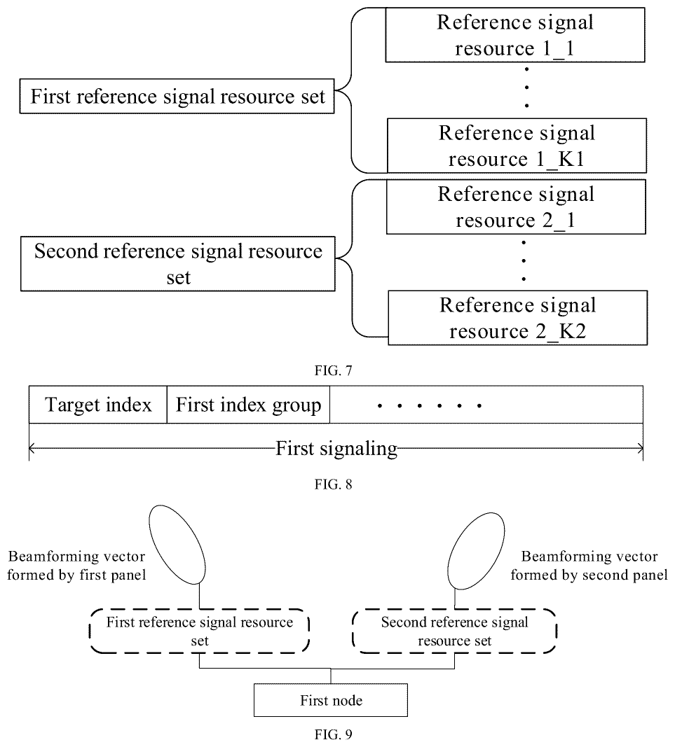

Embodiment 7 illustrates a schematic diagram of a first reference signal resource set and a second reference signal resource set, as shown in FIG. 7. In FIG. 7, the first reference signal resource set comprises K1 reference signal resources, respectively corresponding to reference signal resource 1_1 to reference signal resource 1_K1 in the figure; the second reference signal resource set comprises K2 reference signal resources, respectively corresponding to reference signal resource 2_1 to reference signal resource 2_K2 in the figure; K1 is a positive integer, and the K2 is a positive integer.

In one embodiment, K1 is equal to 1, and the first reference signal resource set only comprises the first reference signal resource in the present application.

In one embodiment, K2 is equal to 1, and the second reference signal resource set only comprises the second reference signal resource in the present application.

In one embodiment, K1 is greater than 1.

In one embodiment, K2 is greater than 1.

In one embodiment, parameters in the first parameter set in the present application are only applicable to the first reference signal resource set.

In one subembodiment of the embodiment, parameters in the first parameter set are applicable to all reference signal resources in the first reference signal resource set.

In one subembodiment of the embodiment, parameters in the first parameter set are applicable to a first reference signal resource in the first reference signal resource set.

In one subembodiment of the embodiment, parameters in the first parameter set are applicable to a reference signal resource in the first reference signal resource set.

In one embodiment, parameters in the second parameter set in the present application are simultaneously applicable to both the first reference signal resource set and the second reference signal resource set.

In one embodiment, parameters in the second parameter set are applicable to all reference signal resources in the first reference signal resource set, as well as all reference signal resources in the second reference signal resource set.

In one subembodiment of the embodiment, parameters in the first parameter set are applicable to a first reference signal resource in the first reference signal resource set, as well as a second reference signal resource in the second reference signal resource set.

In one subembodiment of the embodiment, parameters in the first parameter set are applicable to a reference signal resource in the first reference signal resource set, as well as a reference signal resource in the second reference signal resource set.

In one embodiment, the first reference signal resource set and the second reference signal resource set respectively correspond to two different Panel IDs.

In one embodiment, the first reference signal resource set and the second reference signal resource set respectively correspond to two panels comprised in the first node.

In one embodiment, the first reference signal resource set and the second reference signal resource set respectively correspond to two Radio Frequency (RF) comprised in the first node.

In one embodiment, the first reference signal resource set and the second reference signal resource set respectively correspond to two radio frequency channels comprised in the first node.

### Embodiment 8

Embodiment 8 illustrates a schematic diagram of a first signaling, as shown in FIG. 8. In FIG. 8, the first signaling comprises a target index, and the first signaling comprises a first index group.

In one embodiment, the target index comprised in the first signaling is used to determine an interpretation of the first index group comprised in the first signaling.

In one embodiment, the target index comprised in the first signaling is used to determine a number of bit(s) comprised in the first index group comprised in the first signaling.

In one embodiment, the target index comprised in the first signaling is used to determine whether the first signal is transmitted through one panel or two panels.

In one embodiment, the target index comprised in the first signaling is used to determine whether the first signal is associated with one SRS resource set or two SRS resource sets.

In one embodiment, the target index comprised in the first signaling is used to determine whether the first signal is associated with the first reference signal resource set, or the target index comprised in the first signaling is used to determine whether the first signal is associated with the second reference signal resource set, or the target index comprised in the first signaling is used to determine whether the first signal is associated with both the first reference signal resource set and the second reference signal resource set.

In one embodiment, the first index group comprised in the first signaling is used to determine an SRI adopted by the first signal.

In one embodiment, the first index group comprised in the first signaling is used to determine a PMI adopted by the first signal.

In one embodiment, the first signaling comprises a first field, and the first field of the first signaling is used to determine a power control process adopted by the first signal.

### Embodiment 9

Embodiment 9 illustrates a schematic diagram of a first node, as shown in FIG. 9. In FIG. 9, the first node has two panels, respectively a first panel and a second panel, the first Panel and the second Panel are respectively associated with a first reference signal resource set and a second reference signal resource set; the two panels can transmit two independent radio signals in a same time-frequency resource.

In one embodiment, a maximum transmit power value can be dynamically shared between the first panel and the second panel.

In one embodiment, when the first panel or second panel is used alone, a maximum transmit power value of the first panel or the second panel shall not exceed a first threshold value in the present application.

In one embodiment, when the first panel and the second panel are used simultaneously, a maximum transmit power value of the first panel and a maximum transmit power value of the second panel shall not exceed a second threshold value and a third threshold value in the present application, respectively.

### Embodiment 10

Embodiment 10 illustrates a schematic diagram of an antenna port and an antenna port group, as shown in FIG. 10.

In Embodiment 10, an antenna port group comprises a positive integer number of antenna port(s); one antenna port is formed by superposition of antennas in a positive integer number of antenna group(s) through antenna virtualization; an antenna group comprises a positive integer number of antenna(s). An antenna group is connected to a baseband processor via a Radio Frequency (RF) chain, and different antenna groups correspond to different RF chains. Mapping coefficients from all antennas within a positive integer number of antenna group(s) comprised in a given antenna port to the given antenna port constitute a beamforming vector corresponding to the given antenna port. Mapping coefficients from multiple antennas comprised in any given antenna group within a positive integer number of antenna group(s) comprised in the given antenna port to the given antenna port constitute an analog beamforming vector of the given antenna group. Analog beamforming vectors corresponding to the positive integer number of antenna group(s) are arranged diagonally to form an analog beamforming matrix corresponding to the given antenna port. Mapping coefficients from the positive integer number of antenna group(s) to the given antenna port constitute a digital beamforming vector corresponding to the given antenna port. A beamforming vector corresponding to the given antenna port is acquired from a product of an analog beamforming matrix and a digital beamforming vector corresponding to the given antenna port. Different antenna ports in an antenna port group consist of a same antenna group, and different antenna ports in a same antenna port group correspond to different beamforming vectors.

FIG. 10 illustrates two antenna port groups, namely, antenna port group #0 and antenna port group #1. Herein, the antenna port group #0 consists of antenna group #0, and the antenna port group #1 consists of antenna group #1 and antenna group #2. Mapping coefficients from multiple antennas in the antenna group #0 to the antenna port group #0 constitute analog beamforming vector #0; and mapping coefficients from the antenna group #0 to the antenna port group #0 constitute digital beamforming vector #0; mapping coefficients from multiple antennas of the antenna group #1 and multiple antennas of the antenna group #2 to the antenna port group #1 respectively constitute analog beamforming vector #1 and analog beamforming vector #2; and mapping coefficients from the antenna group #1 and the antenna group #2 to the antenna port group #1 constitute digital beamforming vector #1. A beamforming vector corresponding to any antenna port of the antenna port group #0 is acquired as a product of the analog beamforming vector #0 and the digital beamforming vector #0. A beamforming vector corresponding to any antenna port in the antenna port group #1 is acquired as a product of an analog beamforming matrix formed by the analog beamforming vector #1 and the analog beamforming vector #2 arranged diagonally and the digital beamforming vector #1.

In one subembodiment, an antenna port group comprises an antenna port. For example, the antenna port group #10 in FIG. 10 comprises an antenna port.

In one subsidiary embodiment of the above subembodiment, an analog beamforming matrix corresponding to the antenna port is subjected to dimensionality reduction to form an analog beamforming vector, and a digital beamforming vector corresponding to the antenna port is subjected to dimensionality reduction to form a scaler, a beamforming vector corresponding to the antenna port is equal to an analog beamforming vector corresponding to the antenna port.

In one subembodiment, an antenna port group comprises multiple antenna ports. For example, the antenna port group #1 in FIG. 10 comprises multiple antenna ports.

In one subsidiary embodiment of the above subembodiment, the multiple antenna ports correspond to a same analog beamforming matrix and different digital beamforming vectors.

In one subembodiment, antenna ports in different antenna port groups correspond to different analog beamforming matrices.

In one subembodiment, any two antenna ports in an antenna port group are QCLed (Quasi-Colocated).

In one subembodiment, any two antenna ports in an antenna port group are spatial QCLed.

In one embodiment, multiple antenna port groups in the figure correspond to one panel in the present application.

In one embodiment, the first reference signal resource set corresponds to multiple antenna port groups.

In one embodiment, the second reference signal resource set corresponds to multiple antenna port groups.

In one embodiment, one reference signal resource in the first reference signal resource set corresponds to an antenna port group.

In one embodiment, one reference signal resource in the second reference signal resource set corresponds to an antenna port group.

### Embodiment 11

Embodiment 11 illustrates a structure block diagram of in a first node, as shown in FIG. 11. In FIG. 11, the first node 1100 comprises a first receiver 1101 and a first transmitter 1102.

The first receiver 1101 receives a first information set, the first information set is used to indicate a first parameter set and a second parameter set; and receives a first signaling;
the first transmitter 1102 transmits a first signal;

In embodiment 11, transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, when the first signaling is used to indicate at least one reference signal resource in the second reference signal resource set, the target parameter set is the second parameter set; when the first signaling is not used to indicate reference signal resources in the second reference signal resource set, the target parameter set is the first parameter set.

In one embodiment, when the first signaling is used to indicate at least one reference signal resource in the second reference signal resource set, the first signal comprises a first sub-signal and a second sub-signal, and the first reference signal resource set and the second reference signal resource set are respectively used to determine Spatial Tx parameters of the first sub-signal and the second sub-signal; when the first signaling is not used to indicate reference signal resources in the second reference signal resource set, only the first reference signal resource set in the first reference signal resource set and the second reference signal resource set is used to determine Spatial Tx parameters of the first signal.

In one embodiment, the first parameter set comprises a first value, and the second parameter set comprises a second value and a third value; the first value and the second value are both for the first reference signal resource set, and the first value and the second value are different; when the first signaling is used to indicate at least one reference signal resource in the second reference signal resource set, the first signal comprises a first sub-signal and a second sub-signal, and the second value and the third value are respectively used to determine a transmit power value of the first sub-signal and a transmit power value the second sub-signal; when the first signaling is not used to indicate reference signal resources in the second reference signal resource set, the first value is used to determine a transmit power value of the first signal.

In one embodiment, the first parameter set comprises a first coefficient, and the second parameter set comprises a second coefficient and a third coefficient; when the first signaling is used to indicate at least one reference signal resource in the second reference signal resource set, the first signal comprises a first sub-signal and a second sub-signal, a product of the second coefficient and a first pathloss is used to determine a transmit power value of the first sub-signal, and a product of the third coefficient and a second pathloss is used to determine a transmit power value of the second sub-signal; when the first signaling is not used to indicate reference signal resources in the second reference signal resource set, a product of the first coefficient and a first pathloss is used to determine a transmit power value of the first signal; reference signal resources indicated by the first signaling in the first reference signal resource set are used to determine a third reference signal resource, and reference signal resources indicated by the first signaling in the second reference signal resource set are used to determine a fourth reference signal resource; a radio signal received in the third reference signal resource is used to determine the first pathloss, and a radio signal received in the fourth reference signal resource is used to determine the second pathloss.

In one embodiment, the first signaling comprises a first index group; when the first signaling is used to indicate at least one reference signal resource in the second reference signal resource set, the first signal comprises a first sub-signal and a second sub-signal, and the first index group is used to determine a pre-coding matrix indication respectively adopted by the first sub-signal and the second sub-signal; when the first signaling is not used to determine the second reference signal resource, the first index group is used to determine a precoding matrix indication adopted by the first signal.

In one embodiment, the first signaling comprises a first index group, the first index group is used to determine a first reference signal resource subset from the first reference signal resource set, or the first index group is used to simultaneously determine a first reference signal resource subset from the first reference signal resource set and a second reference signal resource subset from the second reference signal resource set.

In one embodiment, the first receiver 1101 comprises at least first four of the antenna 452, the receiver 454, the multi-antenna receiving processor 458, the receiving processor 456 and the controller/processor 459 in Embodiment 4.

In one embodiment, the first transmitter 1102 comprises at least the first four of the antenna 452, the transmitter 454, the multi-antenna transmitting processor 457, the transmitting processor 468 and the controller/processor 459 in embodiment 4.

In one embodiment, the first information set is transmitted through an RRC signaling, and both the first parameter set and the second parameter set are both used for uplink power control corresponding to a same SRS resource, and the first signaling is a DCI; the first signaling is used to indicate that one of the first parameter set and the second parameter set is used to determine a transmit power value of the first signal.

### Embodiment 12

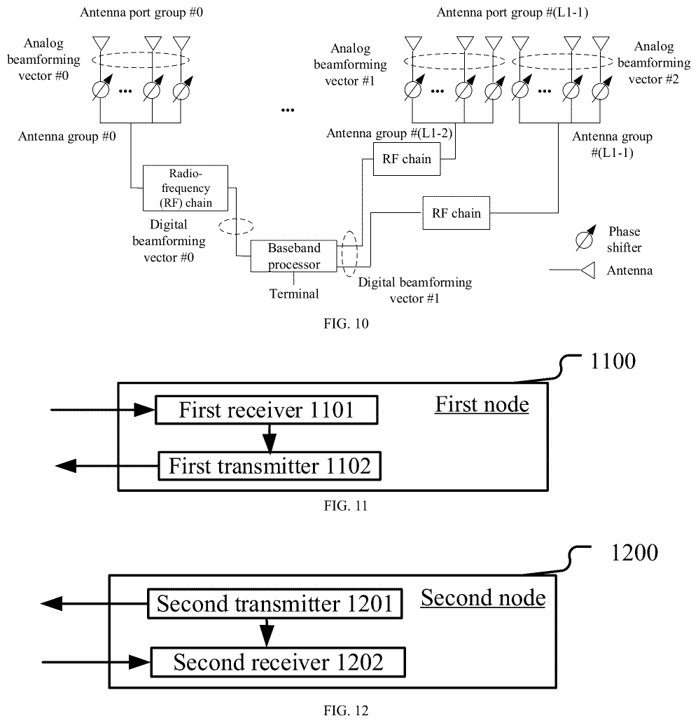

Embodiment 12 illustrates a structure block diagram of in a second node, as shown in FIG. 12. In FIG. 12, the second node 1200 comprises a second transmitter 1201 and a second receiver 1202.

The second transmitter 1201 transmits a first information set, the first information set is used to indicate a first parameter set and a second parameter set; and transmits a first signaling;
the second receiver 1202 receives a first signal;
in embodiment 12, transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

In one embodiment, when the first signaling is used to indicate at least one reference signal resource in the second reference signal resource set, the target parameter set is the second parameter set; when the first signaling is not used to indicate reference signal resources in the second reference signal resource set, the target parameter set is the first parameter set.

In one embodiment, when the first signaling is used to indicate at least one reference signal resource in the second reference signal resource set, the first signal comprises a first sub-signal and a second sub-signal, and the first reference signal resource set and the second reference signal resource set are respectively used to determine Spatial Tx parameters of the first sub-signal and the second sub-signal; when the first signaling is not used to indicate reference signal resources in the second reference signal resource set, only the first reference signal resource set in the first reference signal resource set and the second reference signal resource set is used to determine Spatial Tx parameters of the first signal.

In one embodiment, the first parameter set comprises a first value, and the second parameter set comprises a second value and a third value; the first value and the second value are both for the first reference signal resource set, and the first value and the second value are different; when the first signaling is used to indicate at least one reference signal resource in the second reference signal resource set, the first signal comprises a first sub-signal and a second sub-signal, and the second value and the third value are respectively used to determine a transmit power value of the first sub-signal and a transmit power value the second sub-signal; when the first signaling is not used to indicate reference signal resources in the second reference signal resource set, the first value is used to determine a transmit power value of the first signal.

In one embodiment, the first parameter set comprises a first coefficient, and the second parameter set comprises a second coefficient and a third coefficient; when the first signaling is used to indicate at least one reference signal resource in the second reference signal resource set, the first signal comprises a first sub-signal and a second sub-signal, a product of the second coefficient and a first pathloss is used to determine a transmit power value of the first sub-signal, and a product of the third coefficient and a second pathloss is used to determine a transmit power value of the second sub-signal; when the first signaling is not used to indicate reference signal resources in the second reference signal resource set, a product of the first coefficient and a first pathloss is used to determine a transmit power value of the first signal; reference signal resources indicated by the first signaling in the first reference signal resource set are used to determine a third reference signal resource, and reference signal resources indicated by the first signaling in the second reference signal resource set are used to determine a fourth reference signal resource; a radio signal received in the third reference signal resource is used to determine the first pathloss, and a radio signal received in the fourth reference signal resource is used to determine the second pathloss.

In one embodiment, the first signaling comprises a first index group; when the first signaling is used to indicate at least one reference signal resource in the second reference signal resource set, the first signal comprises a first sub-signal and a second sub-signal, and the first index group is used to determine a pre-coding matrix indication respectively adopted by the first sub-signal and the second sub-signal; when the first signaling is not used to determine the second reference signal resource, the first index group is used to determine a precoding matrix indication adopted by the first signal.

In one embodiment, the first signaling comprises a first index group, the first index group is used to determine a first reference signal resource subset from the first reference signal resource set, or the first index group is used to simultaneously determine a first reference signal resource subset from the first reference signal resource set and a second reference signal resource subset from the second reference signal resource set.

In one embodiment, the second transmitter 1201 comprises at least first four of the antenna 420, the transmitter 418, the multi-antenna transmitting processor 471, the transmitting processor 414 and the controller/processor 475 in Embodiment 4.

In one embodiment, the second receiver 1202 comprises at least the first four of the antenna 420, the receiver 418, the multi-antenna receiving processor 472, the receiving processor 470 and the controller/processor 475 in embodiment 4.

In one embodiment, the first information set is transmitted through an RRC signaling, and both the first parameter set and the second parameter set are both used for uplink power control corresponding to a same SRS resource, and the first signaling is a DCI; the first signaling is used to indicate that one of the first parameter set and the second parameter set is used to determine a transmit power value of the first signal.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, telecontrolled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information set, the first information set being used to indicate a first parameter set and a second parameter set; and receiving a first signaling; and
a first transmitter, transmitting a first signal;
wherein transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

2. The first node according to claim 1, wherein when the first signaling is used to indicate at least one reference signal resource in the second reference signal resource set, the target parameter set is the second parameter set; when the first signaling is not used to indicate reference signal resources in the second reference signal resource set, the target parameter set is the first parameter set.

3. The first node according to claim 1, wherein when the first signaling is used to indicate at least one reference signal resource in the second reference signal resource set, the first signal comprises a first sub-signal and a second sub-signal, and the first reference signal resource set and second reference signal resource set are respectively used to determine Spatial Tx parameters of the first sub-signal and second sub-signal; when the first signaling is not used to indicate reference signal resources in the second reference signal resource set, only the first reference signal resource set in the first reference signal resource set and the second reference signal resource set is used to determine Spatial Tx parameters of the first signal.

4. The first node according to claim 1, wherein the first parameter set comprises a first value, and the second parameter set comprises a second value and a third value; the first value and the second value are both for the first reference signal resource set, and the first value and the second value are different; when the first signaling is used to indicate at least one reference signal resource in the second reference signal resource set, the first signal comprises a first sub-signal and a second sub-signal, and the second value and the third value are respectively used to determine a transmit power value of the first sub-signal and a transmit power value the second sub-signal; when the first signaling is not used to indicate reference signal resources in the second reference signal resource set, the first value is used to determine a transmit power value of the first signal.

5. The first node according to claim 1, wherein the first parameter set comprises a first coefficient, and the second parameter set comprises a second coefficient and a third coefficient; when the first signaling is used to indicate at least one reference signal resource in the second reference signal resource set, the first signal comprises a first sub-signal and a second sub-signal, a product of the second coefficient and a first pathloss is used to determine a transmit power value of the first sub-signal, and a product of the third coefficient and a second pathloss is used to determine a transmit power value of the second sub-signal; when the first signaling is not used to indicate reference signal resources in the second reference signal resource set, a product of the first coefficient and a first pathloss is used to determine a transmit power value of the first signal; reference signal resources indicated by the first signaling in the first reference signal resource set are used to determine a third reference signal resource, and reference signal resources indicated by the first signaling in the second reference signal resource set are used to determine a fourth reference signal resource; a radio signal received in the third reference signal resource is used to determine the first pathloss, and a radio signal received in the fourth reference signal resource is used to determine the second pathloss.

6. The first node according to claim 1, wherein the first signaling comprises a first index group; when the first signaling is used to indicate at least one reference signal resource in the second reference signal resource set, the first signal comprises a first sub-signal and a second sub-signal, and the first index group is used to determine a pre-coding matrix indication respectively adopted by the first sub-signal and the second sub-signal; when the first signaling is not used to determine the second reference signal resource, the first index group is used to determine a precoding matrix indication adopted by the first signal.

7. The first node according to claim 1, wherein the first signaling comprises a first index group, the first index group is used to determine a first reference signal resource subset from the first reference signal resource set, or the first index group is used to simultaneously determine a first reference signal resource subset from the first reference signal resource set and a second reference signal resource subset from the second reference signal resource set.

8. A second node for wireless communications, comprising:
a second transmitter, transmitting a first information set, the first information set being used to indicate a first parameter set and a second parameter set; and transmitting a first signaling; and
a second receiver, receiving a first signal;
wherein transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

9. The second node according to claim 8, wherein when the first signaling is used to indicate at least one reference signal resource in the second reference signal resource set, the target parameter set is the second parameter set; when the first signaling is not used to indicate reference signal resources in the second reference signal resource set, the target parameter set is the first parameter set.

10. The second node according to claim 8, wherein when the first signaling is used to indicate at least one reference signal resource in the second reference signal resource set, the first signal comprises a first sub-signal and a second sub-signal, and the first reference signal resource set and second reference signal resource set are respectively used to determine Spatial Tx parameters of the first sub-signal and second sub-signal; when the first signaling is not used to indicate reference signal resources in the second reference signal resource set, only the first reference signal resource set in the first reference signal resource set and the second reference signal resource set is used to determine Spatial Tx parameters of the first signal.

11. The second node according to claim 8, wherein the first parameter set comprises a first value, and the second parameter set comprises a second value and a third value; the first value and the second value are both for the first reference signal resource set, and the first value and the second value are different; when the first signaling is used to indicate at least one reference signal resource in the second reference signal resource set, the first signal comprises a first sub-signal and a second sub-signal, and the second value and the third value are respectively used to determine a transmit power value of the first sub-signal and a transmit power value the second sub-signal; when the first signaling is not used to indicate reference signal resources in the second reference signal resource set, the first value is used to determine a transmit power value of the first signal.

12. The second node according to claim 8, wherein the first parameter set comprises a first coefficient, and the second parameter set comprises a second coefficient and a third coefficient; when the first signaling is used to indicate at least one reference signal resource in the second reference signal resource set, the first signal comprises a first sub-signal and a second sub-signal, a product of the second coefficient and a first pathloss is used to determine a transmit power value of the first sub-signal, and a product of the third coefficient and a second pathloss is used to determine a transmit power value of the second sub-signal; when the first signaling is not used to indicate reference signal resources in the second reference signal resource set, a product of the first coefficient and a first pathloss is used to determine a transmit power value of the first signal; reference signal resources indicated by the first signaling in the first reference signal resource set are used to determine a third reference signal resource, and reference signal resources indicated by the first signaling in the second reference signal resource set are used to determine a fourth reference signal resource; a radio signal received in the third reference signal resource is used to determine the first pathloss, and a radio signal received in the fourth reference signal resource is used to determine the second pathloss.

13. The second node according to claim 8, wherein the first signaling comprises a first index group; when the first signaling is used to indicate at least one reference signal resource in the second reference signal resource set, the first signal comprises a first sub-signal and a second sub-signal, and the first index group is used to determine a pre-coding matrix indication respectively adopted by the first sub-signal and the second sub-signal; when the first signaling is not used to determine the second reference signal resource, the first index group is used to determine a precoding matrix indication adopted by the first signal.

14. The second node according to claim 8, wherein the first signaling comprises a first index group, the first index group is used to determine a first reference signal resource subset from the first reference signal resource set, or the first index group is used to simultaneously determine a first reference signal resource subset from the first reference signal resource set and a second reference signal resource subset from the second reference signal resource set.

15. A method in a first node for wireless communications, comprising:
receiving a first information set, the first information set being used to indicate a first parameter set and a second parameter set; and receiving a first signaling; and
transmitting a first signal;
wherein transmit power of the first signal is a first power value; the first parameter set and the second parameter set are both associated with a first reference signal resource set, and the first signaling indicates at least one reference signal resource in the first reference signal resource set; a target parameter set is one of the first parameter set and the second parameter set, and at least one candidate parameter comprised in the target parameter set is used to determine the first power value; whether the first signaling is used to indicate at least one reference signal resource in a second reference signal resource set is used to determine the target parameter set from the first parameter set and the second parameter set; the second reference signal resource set is different from the first reference signal resource set.

16. The method in a first node according to claim 15, wherein when the first signaling is used to indicate at least one reference signal resource in the second reference signal resource set, the target parameter set is the second parameter set; when the first signaling is not used to indicate reference signal resources in the second reference signal resource set, the target parameter set is the first parameter set.

17. The method in a first node according to claim 15, wherein when the first signaling is used to indicate at least one reference signal resource in the second reference signal resource set, the first signal comprises a first sub-signal and a second sub-signal, and the first reference signal resource set and second reference signal resource set are respectively used to determine Spatial Tx parameters of the first sub-signal and second sub-signal; when the first signaling is not used to indicate reference signal resources in the second reference signal resource set, only the first reference signal resource set in the first reference signal resource set and the second reference signal resource set is used to determine Spatial Tx parameters of the first signal.

18. The method in a first node according to claim 15, wherein the first parameter set comprises a first value, and the second parameter set comprises a second value and a third value; the first value and the second value are both for the first reference signal resource set, and the first value and the second value are different; when the first signaling is used to indicate at least one reference signal resource in the second reference signal resource set, the first signal comprises a first sub-signal and a second sub-signal, and the second value and the third value are respectively used to determine a transmit power value of the first sub-signal and a transmit power value the second sub-signal; when the first signaling is not used to indicate reference signal resources in the second reference signal resource set, the first value is used to determine a transmit power value of the first signal.

19. The method in a first node according to claim 15, wherein the first parameter set comprises a first coefficient, and the second parameter set comprises a second coefficient and a third coefficient; when the first signaling is used to indicate at least one reference signal resource in the second reference signal resource set, the first signal comprises a first sub-signal and a second sub-signal, a product of the second coefficient and a first pathloss is used to determine a transmit power value of the first sub-signal, and a product of the third coefficient and a second pathloss is used to determine a transmit power value of the second sub-signal; when the first signaling is not used to indicate reference signal resources in the second reference signal resource set, a product of the first coefficient and a first pathloss is used to determine a transmit power value of the first signal; reference signal resources indicated by the first signaling in the first reference signal resource set are used to determine a third reference signal resource, and reference signal resources indicated by the first signaling in the second reference signal resource set are used to determine a fourth reference signal resource; a radio signal received in the third reference signal resource is used to determine the first pathloss, and a radio signal received in the fourth reference signal resource is used to determine the second pathloss.

20. The method in a first node according to claim 15, wherein the first signaling comprises a first index group; when the first signaling is used to indicate at least one reference signal resource in the second reference signal resource set, the first signal comprises a first sub-signal and a second sub-signal, and the first index group is used to determine a pre-coding matrix indication respectively adopted by the first sub-signal and the second sub-signal; when the first signaling is not used to determine the second reference signal resource, the first index group is used to determine a precoding matrix indication adopted by the first signal;
or,
the first signaling comprises a first index group, the first index group is used to determine a first reference signal resource subset from the first reference signal resource set, or the first index group is used to simultaneously determine a first reference signal resource subset from the first reference signal resource set and a second reference signal resource subset from the second reference signal resource set.
